(19) United States
(12) Patent Application Publication
(10) Pub. No.: US 2015/0100460 A1
(43) Pub. Date: Apr. 9, 2015

(54) ARRANGING SAFE AND CONVENIENT TRANSACTIONS

(71) Applicants: Polly Howden, London (GB); Dennis Cheung, Sunnyvale, CA (US); Erskine A. Williams, Portland, OR (US); Myra Wong Liu, San Francisco, CA (US); Dean Amstutz, Chula Vista, CA (US); Francesca Cuda, London (GB); Paul D. MacDonald, Berkshire (GB); Leanne Tite, London (GB)

(72) Inventors: Polly Howden, London (GB); Dennis Cheung, Sunnyvale, CA (US); Erskine A. Williams, Portland, OR (US); Myra Wong Liu, San Francisco, CA (US); Dean Amstutz, Chula Vista, CA (US); Francesca Cuda, London (GB); Paul D. MacDonald, Berkshire (GB); Leanne Tite, London (GB)

(21) Appl. No.: 14/138,018

(22) Filed: Dec. 21, 2013

Related U.S. Application Data
(60) Provisional application No. 61/887,161, filed on Oct. 4, 2013.

(51) Int. Cl. G06Q 30/06

(52) U.S. Cl. CPC G06Q 30/0609; G06Q 30/0633
USPC 705/26.35; 705/26.8

(57) ABSTRACT

Systems and methods to arrange transactions are described. A transaction request may be received from transaction parties. The transaction request may include transaction data. Geographic region data associated with the transaction parties using the transaction data may be retrieved. A mutual geographic region based on the geographic region data may be determined. Suggested transaction locations based on the mutual geographic region may be determined. The suggested transaction locations may be recommended to the transaction parties.

### RELATED APPLICATIONS

This application claims the priority benefit of U.S. Provisional Application No. 61/887,161, entitled “ARRANGING SAFE AND CONVENIENT TRANSACTIONS,” filed Oct. 4, 2013, which is hereby incorporated herein by reference in its entirety.

### TECHNICAL FIELD

Embodiments of the present invention relate generally to systems and methods for arranging transactions between parties.

### BACKGROUND

With the increased prevalence of communications technologies and the Internet, it has become commonplace to interact with and transact with strangers. Transactions are often conducted between parties that previously have not met or know each other. Often these in-person transactions are in cash for items that can be of high value. When performing in-person transactions the opportunity for maleficence is abundant and safety is always a concern.

### BRIEF DESCRIPTION OF THE DRAWINGS

Various ones of the appended drawings merely illustrate example embodiments of the present invention and cannot be considered as limiting its scope.

FIG. 1 is a block diagram of a networked system depicting an example embodiment.

FIG. 2 is a block diagram of server applications that may form a part of the network system of FIG. 1, according to example embodiments.

FIG. 3 is a block diagram illustrating social network information, according to an example embodiment.

FIG. 4 is a block diagram illustrating a mobile device, according to an example embodiment.

FIG. 5 is a block diagram depicting an example embodiment of a transaction arrangement system.

FIG. 6 is a flow diagram illustrating an example embodiment for performing a transaction.

FIGS. 7-14 are flow diagrams illustrating example embodiments for arranging a transaction.

FIGS. 15A-15D depict example user interfaces for performing a transaction and arranging a transaction.

FIG. 16 is an example embodiment of a computer system in conjunction with the present invention.

### DETAILED DESCRIPTION

Example methods and systems to arrange transactions are described. In the following description, for purposes of explanation, numerous specific details are set forth in order to provide a thorough understanding of example embodiments. It will be evident, however, to one skilled in the art that the present invention may be practiced without these specific details.

Embodiments described herein may include arranging a transaction based on data retrieved from various sources between transaction parties. In an example embodiment, a transaction request may be received from a transaction party. The transaction request may include transaction data. The transaction data may comprise various transaction information including transaction party identifiers. Geographic region data associated with the transaction parties (e.g., associated with the transaction parties via the transaction data) may be retrieved from one or more application servers or may be included in the transaction data. The geographic region data may be used to determine a mutual geographic region. Suggested transaction locations based on the mutual geographic region may be determined and further may be recommended to the transaction parties. The suggested transaction locations may be determined by analyzing data retrieved from various sources. In some embodiments, a transaction location selection may be received from the parties and the transaction location selection may be stored in a database, to be used in additional analysis in the future.

In further embodiments, scheduling data associated with the transaction parties may be retrieved and a mutually available schedule may be determined based on the scheduling data. Suggested transaction times may be determined and further recommended to the transaction parties based on the mutually available schedule and analysis of other information.

In still further embodiments, party verification data may be retrieved and presented to the transaction parties. For example, the party verification data may include party images. In some embodiments, the party images are verified as being an image of a person using image recognition software or hardware. In further embodiments, the party images may be used to verify the identity of the transaction parties using imaging software or hardware. In an example embodiment, party verification data may be required to complete the arrangement of the transaction (e.g., require a party image or the transaction will not be arranged). Party verification data may include a variety of information. For example, criminal history, prior ratings or reviews related to the transaction parties, credit reports, and so forth. The party verification data may be presented to the transaction parties to allow for an assessment of the safety or legitimacy of the transaction. The party images may also allow for easier in-person identification when meeting for the transaction.

In some embodiments, item verification data may be retrieved and presented to the transaction parties. The item verification data may include item images or in a further embodiment a receipt for original purchase of the item. In some embodiments, the item images may be required to complete arrangement of the transaction. The item verification data may be presented to the purchasing party to allow for assessment of the quality or authenticity of the item.

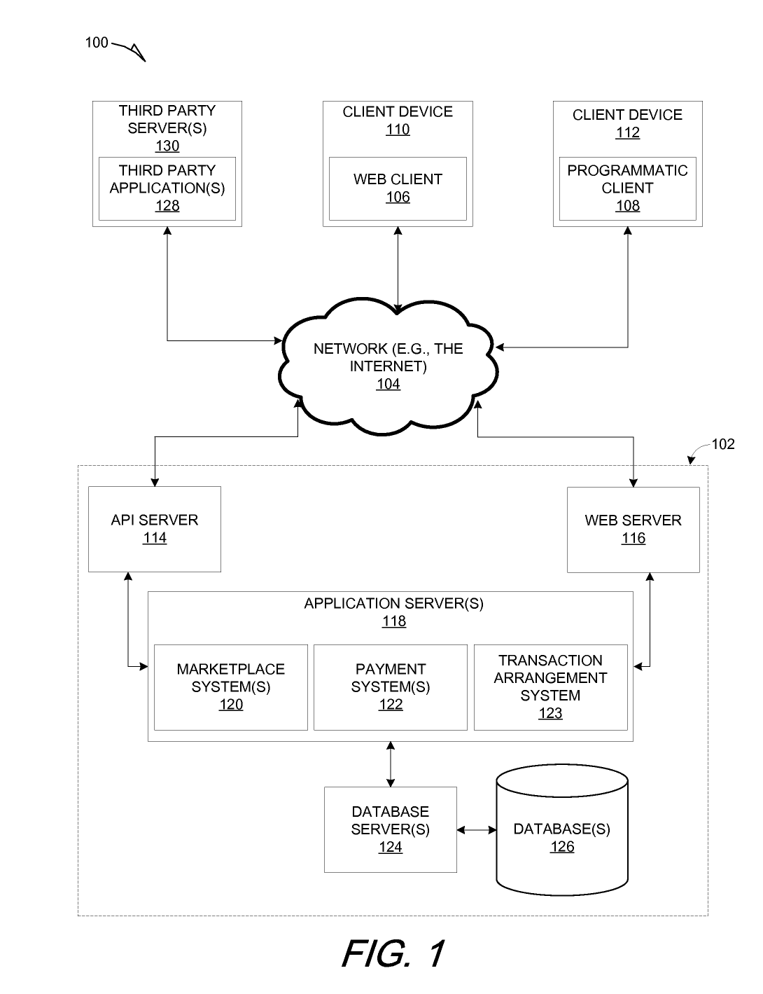

With reference to FIG. 1, an example embodiment of a high-level client-server-based network architecture 100 to enable transaction arrangement is shown. A networked system 102, in the example forms of a network-based marketplace or payment system, provides server-side functionality, via a network 104 (e.g., the Internet or Wide Area Network (WAN)) to one or more clients devices 110 and 112. FIG. 1 illustrates, for example, a web client 106 (e.g., a browser, such as the Internet Explorer browser developed by Microsoft Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screen, accelerometer, gyroscope, camera, microphone, and GPS device. The client devices 110 and 112 may be a device of a user, which is used to perform a transaction involving digital goods within the networked system 102. In one embodiment, the networked system 102 is a network-based marketplace that manages digital goods, publishes publications comprising item listings of products available on the network-based marketplace, and manages payments for these marketplace transactions.

An Application Program Interface (API) server 114 and a web server 116 are coupled to, and provide programmatic and web interfaces respectively to, one or more application servers 118. The application servers 118 may host one or more marketplace systems 120, payment systems 122, and transaction arrangement systems 123 each of which may comprise one or more modules or applications and each of which may be embodied as hardware, software, firmware, or any combination thereof. The application servers 118 are, in turn, shown to be coupled to one or more databases servers 124 that facilitate access to one or more to one or more information storage repositories or database(s) 126. In one embodiment, the databases 126 are storage devices that store information to be posted (e.g., publications or listings) to the marketplace system 120. The databases 126 may also store digital goods information in accordance with example embodiments.

The marketplace system 120 may provide a number of marketplace functions and services to users that access the networked system 102. The payment system 122 may likewise provide a number of payment services and functions to users. The payment system 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace system 120. The transaction arrangement system 123 may provide functionality for arranging transactions between parties. While the marketplace, payment, and transaction arrangement systems 120, 122, and 123 are shown in FIG. 1 to both form part of the networked system 102, it will be appreciated that, in alternative embodiments, the payment system 122 may form part of a payment service that is separate and distinct from the networked system 102. Similarly, it is to be appreciated that the transaction arrangement system 123 may also be separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace, payment, and transaction arrangement systems 120, 122, and 123 could also be implemented as standalone software programs, which do not necessarily have networking capabilities.

The web client 106 accesses the various marketplace, payment, and transaction arrangement systems 120, 122, and 123 via the web interface supported by the web server 116. Similarly, the programmatic client 108 accesses the various services and functions provided by the marketplace, payment, and transaction arrangement systems 120, 122, and 123 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application(s) 128, executing on a third party server(s) 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, transaction arrangement, or payment functions that are supported by the relevant applications of the networked system 102.

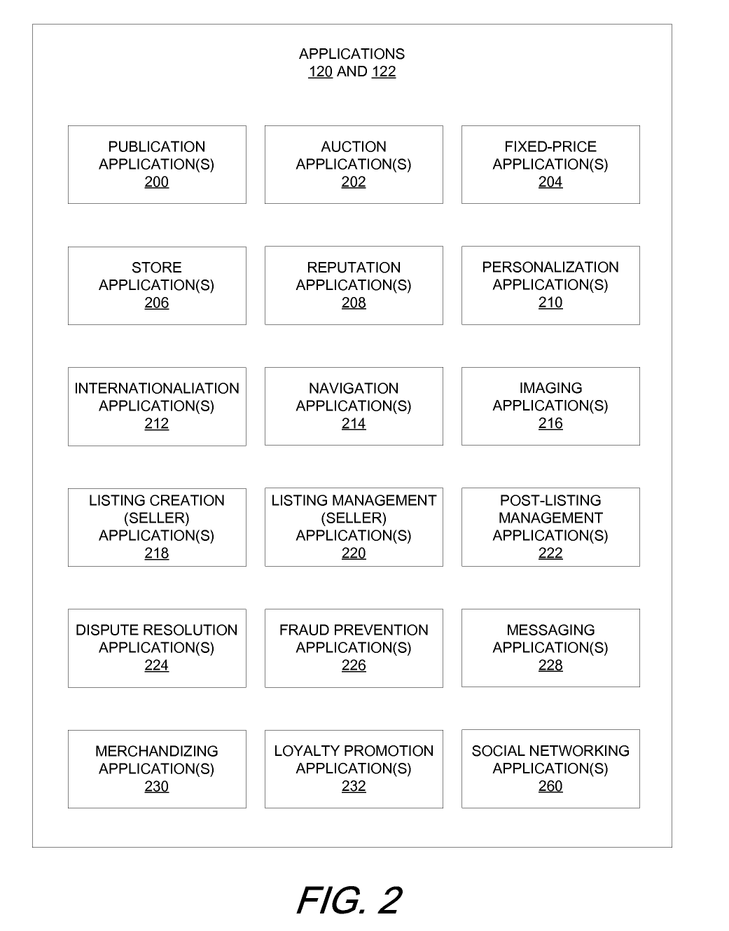

FIG. 2 is a block diagram illustrating multiple applications or systems 120 and 122 that, in one example embodiment, are provided as part of the networked system 102. The applications 120 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browser application may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and be offered a reward for which accumulated loyalty points can be redeemed.

Social networking applications 260 may support various social networking functions that are made available in various embodiments. The social networking functions may include the retrieval or submission of data to and from social networking servers.

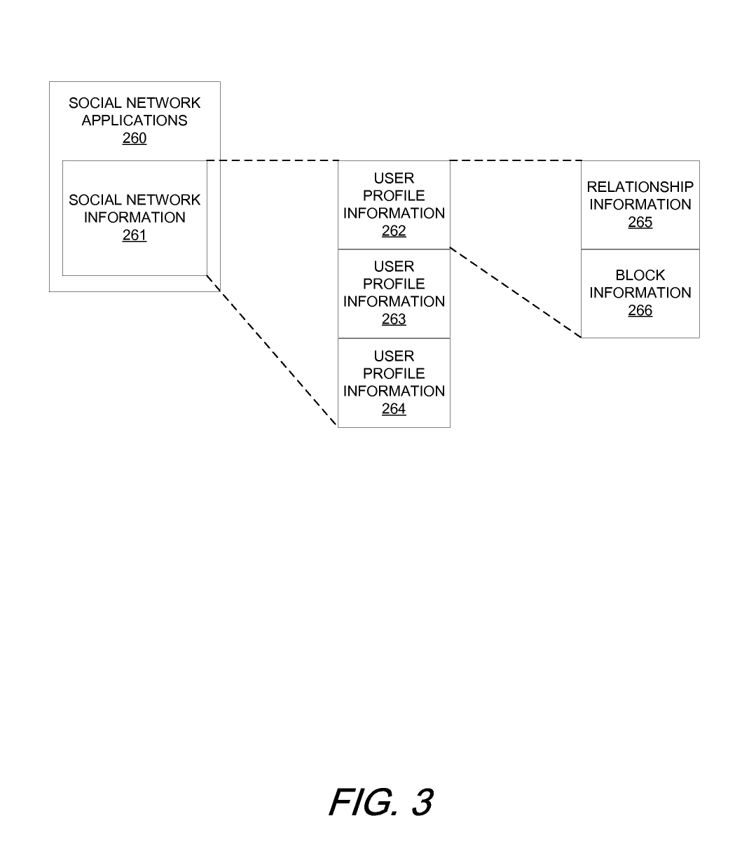

FIG. 3 is a block diagram illustrating social network information 261 that may be used by social network applications 260 of FIG. 2, according to an embodiment, at the networked system 102 of FIG. 1. The social network applications 260 are shown to include social network information 261 that stores user profile information 262 for users of the networked system 102. The user profile information 262 may include information related to the user and specifically may include relationship information 265 and block information 266. The relationship information 265 may store a predetermined relationship between the user associated with the user profile information 262 and other users on the networked system 102. For example, a first user may be designated a “friend,” or “favorite friend,” etc. with a second user, the first user associated with the user profile information 262 and the respective designations associated with increasing levels of disclosure between the first user and second user. The block information 266 may store a configured preference of the user to block the addition of an item by other users to a watch list associated with the user.

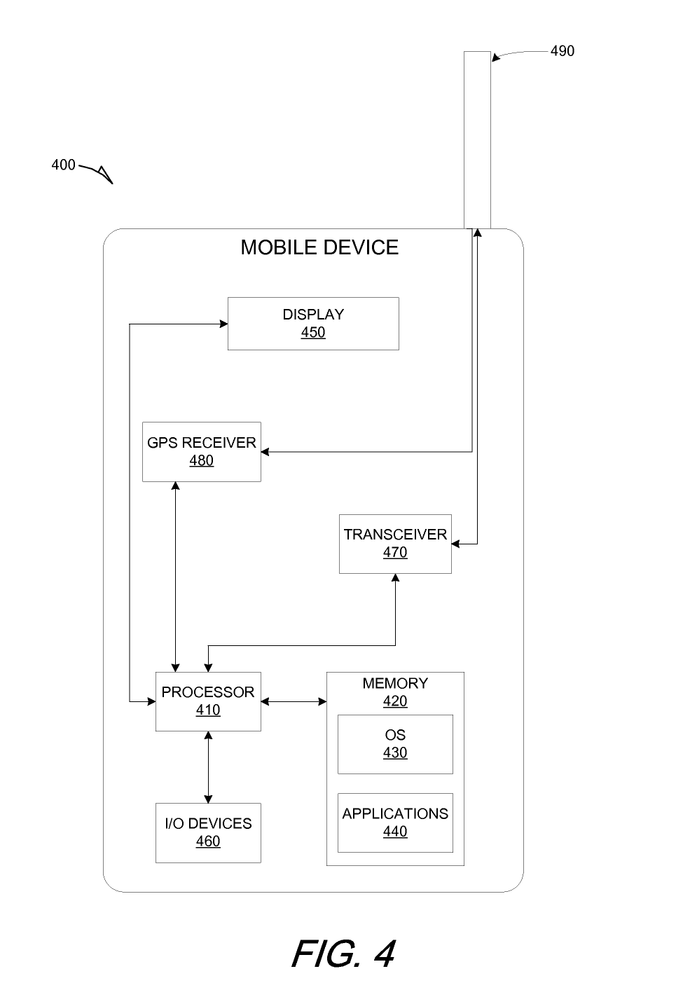

FIG. 4 is a block diagram illustrating a mobile device 400, according to an example embodiment. The mobile device 400 may include a processor 410. The processor 410 may be any of a variety of different types of commercially available processors suitable for mobile devices (e.g., an XScale architecture microprocessor, a Microprocessor without Interlocked Pipeline Stages (MIPS) architecture processor, or another type of processor). A memory 420, such as a Random Access Memory (RAM), a Flash memory, or other type of memory, is typically accessible to the processor. The memory 420 may be adapted to store an operating system (OS) 430, as well as application programs 440, such as a mobile location enabled application that may provide LBSs to a user. The processor 410 may be coupled, either directly or via appropriate intermediary hardware, to a display 450 and to one or more input/output (I/O) devices 460, such as a keypad, a touch panel sensor, a microphone, and the like. Similarly, in some embodiments, the processor 410 may be coupled to a transceiver 470 that interfaces with an antenna 490. The transceiver 470 may be configured to both transmit and receive cellular network signals, wireless data signals, or other types of signals via the antenna 490, depending on the nature of the mobile device 400. In this manner, a connection with a network such as network 104 of FIG. 1 may be established. Further, in some configurations, a GPS receiver 480 may also make use of the antenna 490 to receive GPS signals. Additional details regarding providing and receiving location-based goods and services using a GPS system can be found in U.S. patent application Ser. No. 13/340,626 entitled “Methods and Systems for Using a Co-Located Group as an Authorization Mechanisms,” assigned to the assignee of the instant application, which application is hereby incorporated by reference in its entirety.

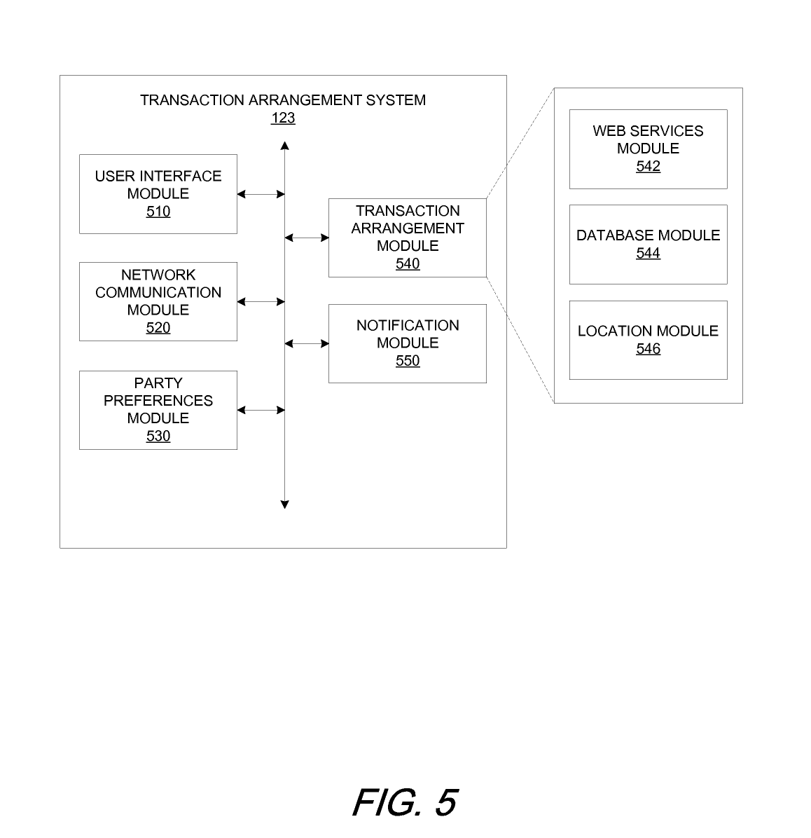

FIG. 5 is a block diagram of the transaction arrangement system 123, which may arrange transactions between two or more transaction parties. In an embodiment, the transaction arrangement system 123 may include a user interface module 510, a network communication module 520, a party preferences module 530, a transaction arrangement module 540, and a notification module 550. In further embodiments, the transaction arrangement module 540 may include a web services module 542, a database module 544, and a location module 546. Other modules not pertinent to example embodiments may also be included, but are not shown.

The user interface module 510 may provide various user interface functionality that may present and receive information from the transaction parties. For example, the user interface module 510 may present various interfaces to the transaction parties to facilitate transaction arrangement such as map displays, schedule displays, transaction party images, item images, transaction information, and so forth. Information may be presented by a number of means including displaying information (e.g., such as on display 450), other visual means, or other device output (e.g., audio, tactile, and so forth). Similarly, information may be received by a number of means including alpha numeric input or other device input (e.g., one or more touch screen, camera, tactile sensors, light sensors, infrared sensors, biometric sensors, microphone, gyroscope, accelerometer, other sensors, and so forth). It will be appreciated that the user interface module 510 may provide many other user interfaces to facilitate functionality described herein.

The network communication module 520 may perform various network communication functions such as communicating with the client devices 110 and 112 and servers such as the application servers 118, the database servers 124, and the third party servers 130. Network communication may operate over WiFi, Bluetooth, or other means of wired or wireless data transmission.

The party preferences module 530 may provide functionality to receive and store party preferences. The party preferences may be received by party preferences module 530 and stored in databases 126, for example. In an example embodiment, the party preferences may include preferences for transaction location, mode of transportation, payment method, requirements to arrange the transaction, and so forth. The requirements to arrange the transaction may include requirements such as providing party verification data (e.g., party images), item verification data (e.g., item images or an original purchase receipt), and so forth. In some embodiments, party verification data and item verification data may be required for every transaction and are not a party preference.

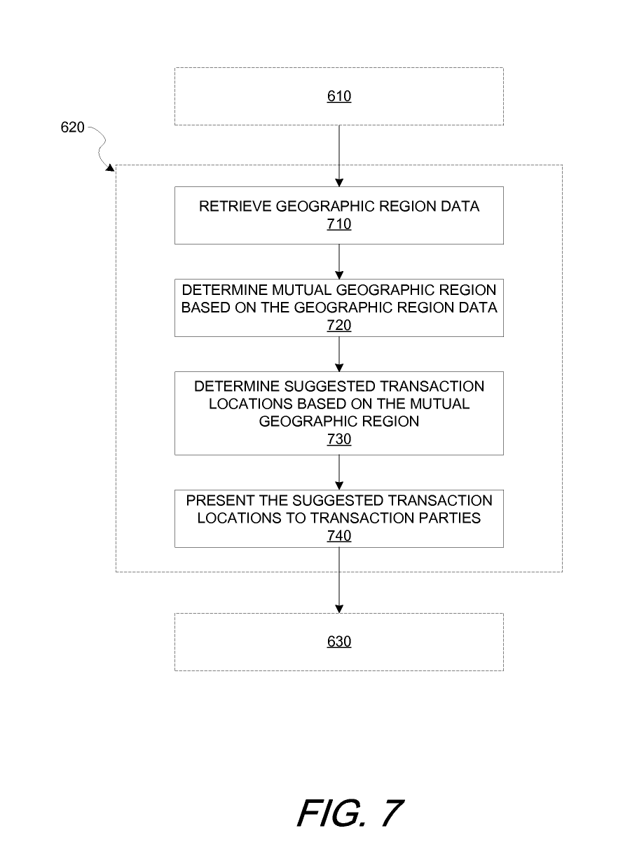

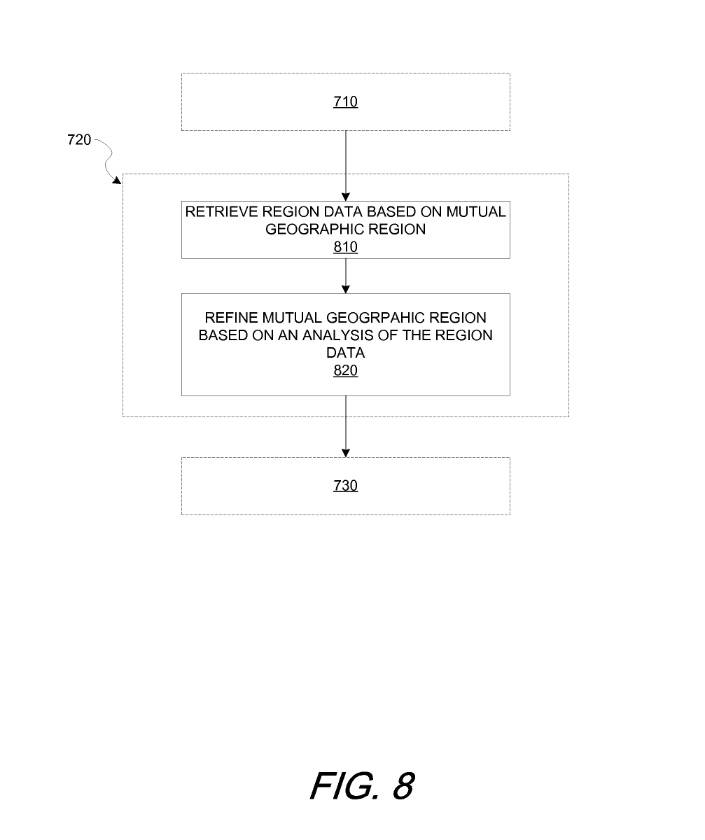

The transaction arrangement module 540 may provide functionality for arranging transactions. A transaction request may be received from one of the transaction parties. The transaction request may include transaction data. The transaction arrangement module 540 may perform a transaction arrangement based on the transaction data and data from other sources. For example, after receiving the transaction request, the transaction arrangement module 540 may retrieve geographic region data associated with the transaction parties using the transaction data, determine a mutual geographic region based on the geographic region data, determine suggested transaction locations based on the mutual geographic region, and recommend the suggested transaction locations to the transaction parties as described in FIG. 7. In further embodiments, the transaction arrangement module 540 may retrieve data from various sources and perform an analysis of the data to determine suggested transaction locations, suggested transaction times, party verifications, and item verifications as described in FIGS. 8-14. The transaction arrangement module 540 may also perform or facilitate transaction payment and other functionality. In embodiments, the transaction arrangement module 540 may facilitate payment processing by communicating transaction information to payment system 122, for example. In other embodiments, the transaction module may receive payment instructions and process payments.

The web services module 542 may perform various web services functions such as retrieving information from third party servers 130 and application servers 118. Information retrieved by the web services module 542 may include transaction data, party data, item data, and other data.

The database module 544 may communicate with the databases 126 to retrieve and store information. For example, the transaction location selections may be received from the transaction parties and stored in databases 126 and in the future may be retrieved by database module 544. In further embodiments, other information associated with the transaction parties, the geographic region, the transaction, or other information may be stored or retrieved in the databases 126.

The location module 546 may retrieve various location information associated with the transaction data. Location information may be retrieved, for example, using IP address geolocation or from other geographic services. In further embodiments, real-time location information may be retrieved from using GPS (e.g., from GPS receiver 480) or another location service. Location information may also be retrieved from third party servers 130, application servers 118, or from another source.

The notification module 550 may provide notification functionality such as communicating transaction schedule notifications, location and party proximity notifications, and transaction notifications. Notifications may deliver electronic mail (e-mail), instant message (IM), Short Message Service (SMS), text, push notification, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

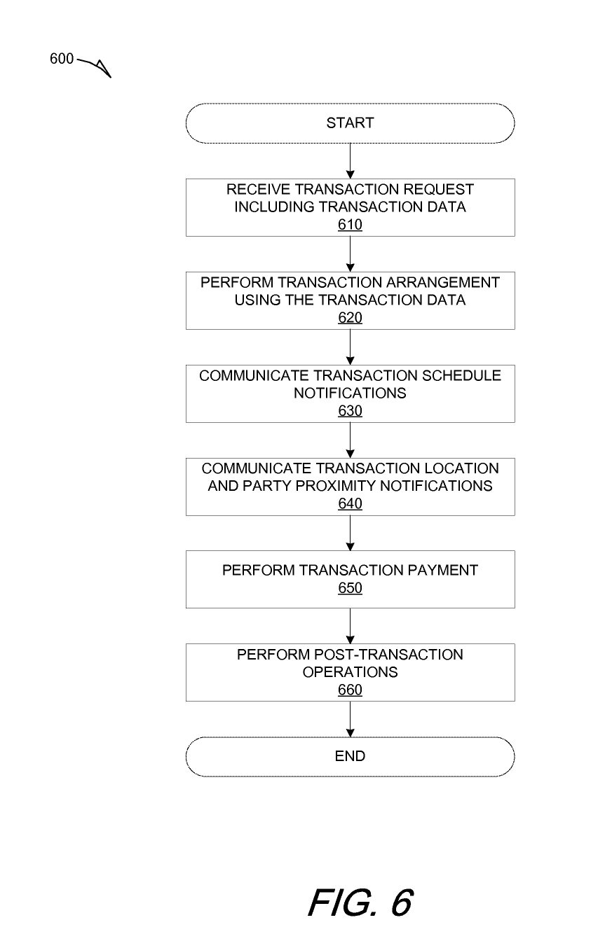

FIG. 6 is a flow diagram illustrating an example method 600 for a transaction. At operation 610, a transaction request including transaction data may be received at the transaction arrangement system 123 from one of the transaction parties (e.g., a transaction client executing on a mobile device). In embodiments, the transaction data may include party identifiers, item identifiers, party names, party region data, party IP addresses, party location data, item price, quantity, item condition, item description, item weight, item dimensions, item quantity, transaction time, device identifier, payment method, currency, and so forth. In an example embodiment, a transaction notification may be communicated to the non-requesting transaction party once a transaction request is received. The transaction notification may include transaction data and may be communicated using notification module 550, in an example embodiment. In some embodiments, additional parties may be invited to the transaction (e.g., parties other than buyers and sellers).

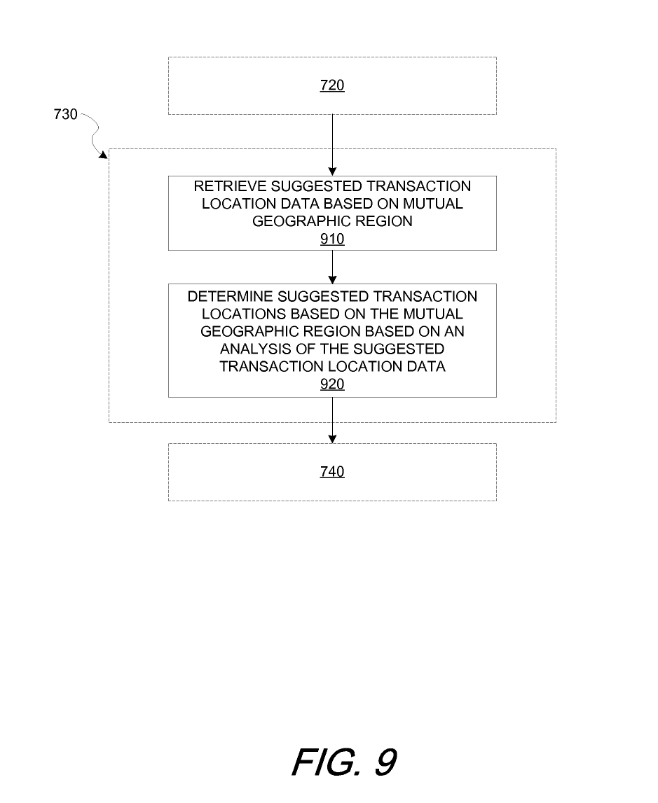

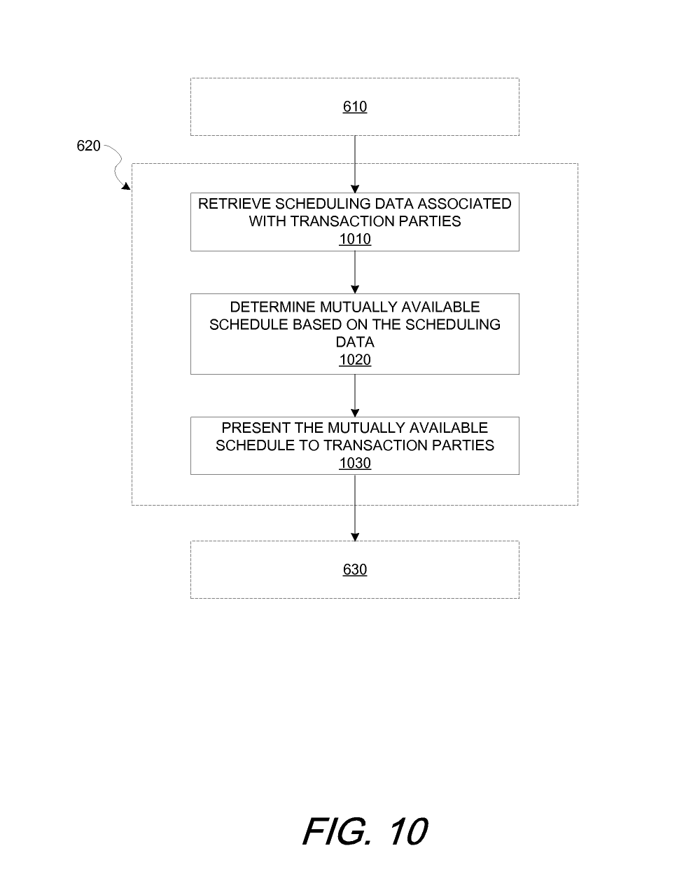

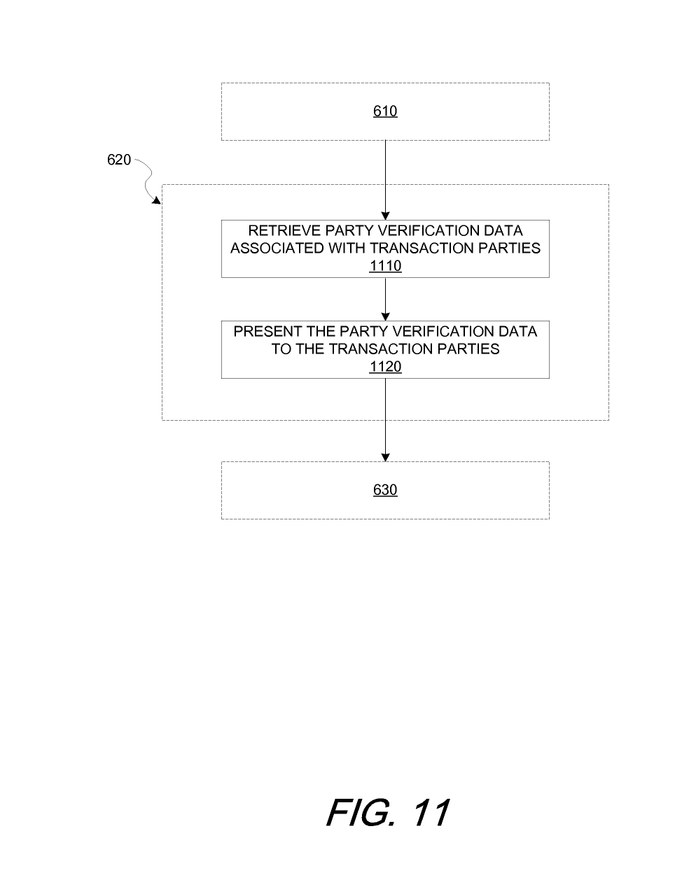

Following a request for a transaction, method 620 may perform the transaction arrangement using the transaction data, as further described in FIG. 7 and FIGS. 10-14. In example embodiment, the transaction arrangement of method 620 may include retrieving data from various sources and analyzing the data to determine suggested transaction locations for the transaction, as described in FIG. 7 and further described in FIG. 8-9, and suggested transaction times, as described in FIG. 10. In further embodiments, data from various sources may be retrieved and used to perform party verifications and item verifications, as described in FIG. 11-14.

In embodiments, a transaction location selection and a transaction time selection may be received from the transaction parties and stored for use in future analysis by method 620. In further embodiments, the transaction location selection may be stored along with associated transaction data or other data. For example, the transaction location selection may be stored and may be associated with transaction parties, the transaction item, the transaction time, other transaction data, or other data. In embodiments, the associated transaction data may be used, for example, to retrieve prior transaction location selections associated with the transaction parties.

After arranging the transaction, the transaction arrangement system 123, at operation 630, may communicate transaction schedule notifications to the transaction parties (e.g., communicated to client devices 110 and 112) as the transaction time approaches. In an embodiment, the transaction schedule notifications may be communicated at a predetermined time before the transaction. In further embodiments, the transaction schedule notifications may be communicated according to stored party preferences, such as the party preferences store by party preferences module 530. Multiple transaction schedule notifications associated with one transaction may be communicated.

At operation 640, the transaction arrangement system 123 may communicate location and party proximity notifications to the transaction parties. The location and party proximity notifications may, for example, include directional information to assist the transaction parties in facilitating the meeting at the transaction location and transaction time. In further embodiments, an estimated time of arrival (ETA) at the transaction location for the transaction parties may be determined and communicated to the other transaction parties. For example, a mobile application operating on a mobile device of one or more of the transaction parties may communicate current location information (as determined by the GPS receiver 480 of the mobile device) to a transaction arrangement system 123. The transaction arrangement system 123 may analyze the current and prior location information to determine a rate of travel and distance to the transaction location and the ETA calculated. Other means of determining ETA may be employed. In further embodiments, the current location information may be communicated between the transaction parties and a distance between the transaction parties calculated and presented to the transaction parties.

At operation 650, the transaction arrangement system 123 may receive and process payment instructions for the transaction using cash or non-cash payment means. In other embodiments, the transaction arrangement system 123 may facilitate payment processing by communicating transaction information to payment system 122, for example. For example, payment for the item may be made using cash, PayPal, another item (e.g., bartering), credit, credit with the location hosting the transaction (e.g., in store credit or gift cards), or other payment means. In some embodiments, near field communication (NFC) or Bluetooth communication may be employed to facilitate payment.

Following completion of the transaction, the transaction arrangement system 123, at operation 660, may perform post-transaction operations. The post-transaction operations may include communicating a receipt for the transaction from the transaction arrangement system 123 to the transaction parties. In further embodiments, the post-transaction operations may include the transaction arrangement system 123 requesting a review of various aspects of the transaction (e.g., a seller rating, a buyer rating, an item rating, a transaction location rating, and so forth) from the transaction parties. The review may be stored in a storage device such as databases 126, to be used in transaction arrangement analysis in the future by the transaction arrangement system 123. In still further embodiments, the post-transaction operations may include storing data associated with the transaction (e.g., item data, the transaction location, the transaction time, the payment method, the transaction parties, and so forth) in a storage device such as databases 126, to be used in transaction arrangement analysis in the future by the transaction arrangement system 123.

The FIG. 7 and FIGS. 10-14 describe further embodiments of method 620 for performing the transaction arrangement. These embodiments may perform the transaction arrangement by analyzing data retrieved from various sources that may include application servers 118, third party servers 130, client devices 110 and 112, databases 126, and other sources. The analysis may determine the mutual geographic region, the suggested transaction locations, the mutually available schedule, party verifications, and item verifications.

FIG. 7 is a flow diagram depicting a further embodiment of the method 620 for performing the transaction arrangement that may determine suggested transaction locations. At operation 710, the transaction arrangement system 123 may retrieve geographic region data associated with the transaction parties using the transaction data. In an example embodiment, the geographic region data may be retrieved from the transaction data (e.g., the transaction data may include party region data or party location data). In some embodiments, the geographic region data may be retrieved from the transaction parties (e.g., from user interface input), from geographic services such as IP address geolocation, device GPS, social networking profiles associated with the transaction data (e.g., transaction data may contain party names or party identifiers which may be used to retrieve data associated with the party), or from other geographic services using location module 546. For example, a mobile application operating on a mobile device of one or more of the transaction parties may communicate current location information (as determined by a GPS unit of the mobile device) to a transaction arrangement system 123.

At operation 720, the transaction arrangement system 123 may determine the mutual geographic region based on the geographic region data as further describe in FIG. 8. The mutual geographic region may be a region that minimizes the geographic distance between the transaction parties. Minimizing geographic distance may minimize the travel time to the transaction location for the transaction parties, but does not necessarily have to be optimal for all or any of the transaction parties. Where the geographic region data is only associated with one of the transaction parties, the mutual geographic region may simply be the region near the party associated with the geographic region data. The distance factor may minimize the travel time to the location for the transaction parties, but does not necessarily have to be optimal for all or any parties to the transaction.

At operation 730, the transaction arrangement system 123 may determine suggested transaction locations based on the mutual geographic region as further described in FIG. 9. The suggested transaction locations may be within the mutual geographic region. For example, suggested locations may be coffee shops, hardware stores, public parks, public parking lots, restaurants, and so forth. In some embodiments, the suggested transaction locations are predetermined and in other embodiments, the suggested transaction locations are dynamically generated based on the mutual geographic region.

At operation 740, the transaction arrangement system 123 may present the suggested transaction locations to the transaction parties. The suggested transaction locations may be presented using user interface module 510. The transaction parties may select a transaction location or negotiate a transaction location. In an example embodiment, a first party may indicate a subset of the suggested transaction locations as being acceptable, a second party may indicate a further subset of the suggested transaction locations as being acceptable, and a negotiation or conversation regarding the final determination of a location may be facilitated. Further, the transaction parties may be given the option to rank the suggested transaction locations according to individual preference, and the transaction arrangement system 123 may automatically determine one of the suggested transaction locations based on ranking information received from both parties.

FIG. 8 depicts a further embodiment of the operation 720 for determining the mutual geographic region. At operation 810, the transaction arrangement system 123 may retrieve region data based on the mutual geographic region. The region data may be retrieved from application servers 118, third party servers 130, client devices 110 and 112, databases 126, and other sources, in example embodiments.

At operation 820, the transaction arrangement system 123 may refine the mutual geographic region based on an analysis of the region data. In an example embodiment, the mutual geographic region may be refined based on region factors including distance, accessibility, availability of public, weather conditions, road conditions, crime statistics of the geographic region, prior transaction locations of the transaction parties, and other factors. The accessibility factor may remove parts of the geographic region that are not accessible by, for example, roads or public transportation. The prior locations factor may favor parts of the region where one or more of the transaction parties have previously conducted a transaction.

FIG. 9 depicts a further embodiment of the operation 730 for determining suggested transaction locations. At operation 910, the transaction arrangement system 123 may retrieve suggested transaction location data based on the mutual geographic region. The suggested transaction location data may be retrieved from application servers 118, third party servers 130, client devices 110 and 112, databases 126, and other sources, in example embodiments.

At operation 920, the transaction arrangement system 123 may determine suggested transaction locations based on the mutual geographic region based on an analysis of the suggested transaction location data. In embodiments, the suggested transactions locations may be within the mutual geographic region or near the mutual geographic region. For example, if there are numerous potential locations within the mutual geographic region, the suggested locations may be within the mutual geographic region. In another example, if there are few or zero potential locations within the mutual geographic region, suggested locations may be outside of the mutual geographic region.

The suggested transaction location data may include location factors to determine the fitness of a suggested transaction location may include one or more of whether the location is open to the public, whether the location has working staff members, prior transaction location selections, prior transaction time selections, accessibility by public transportation, parking availability, crime statistics of the location, operating hours of the location, distance of the location based on the mutual geographic region, distance of the location relative to the location of the parties to the transaction, whether the parties to the transaction have previously been to the location, ratings and reviews of the location, social networking posts about the location, and other factors. For example, suggested locations may include locations that are within the mutual geographic region and that are accessible via public transportation. Many other schemes employing the mutual geographic region and the suggested transaction location data may be used to determine suggested transaction locations.

The suggested transaction locations may be generated dynamically by an analysis of the location factors, using the suggested transaction location data, or may be predetermined. The party preferences with respect to mode of transport or location may also be taken into account when determining the suggested transaction locations. For example, the transaction parties may have party preferences that indicate a preference for public transport. In this example, a location that is proximate to trains or bus routes may be more favorable when determining the suggested transaction locations.

The prior transaction location selections factor may retrieve prior transaction location selections and prior transaction time selections for the transaction parties to determine a preferable location for the transaction. For example, if the transaction parties have in the past performed a transaction at a particular location, then that location may be included in the suggested transaction locations.

In further embodiments, prior transaction location selections and transaction time selections of other transaction parties may be used to determine a preferable location. For example, if transaction parties near London often choose a coffee shop as the transaction location, coffee shops near London may be more preferable and included in the suggested transaction locations.

In an example embodiment, the suggested transaction locations are predetermined. This may involve prior agreements with accessible locations such as hardware stores, coffee shops, and other commercial and non-commercial enterprises. In an embodiment, the commercial enterprise may have entered into an agreement where they provide a safe location for the transactions in exchange for various forms of consideration. Consideration may include but is not limited to an agreement to use store credit or gift cards as a form of payment in the transaction, providing direct monetary payment to the commercial enterprise, or simply encouraging the transaction parties to physically enter premises.

FIG. 10 is a flow diagram depicting a further embodiment of the method 620 for performing the transaction arrangement that may determine a mutually available schedule. At operation 1010, the transaction arrangement system 123 may retrieve scheduling data associated with the transaction parties. The scheduling data may include scheduling data for the parties, scheduling data for the location, scheduling data for public transportation, scheduling data for other forms of transportation, or other scheduling data. The scheduling data may be received from the parties to the transaction (e.g., input from a user interface), from data stored on one or more of the parties to the transaction's devices, from online accounts of the transaction parties, from publicly available information such as government websites (e.g., transaction data may contain party names or party identifiers which may be used to retrieve data associated with the party), from commercial websites, predefined scheduling information for locations, predefined scheduling information for transportation systems, or from other sources.

After receiving the scheduling data, the transaction arrangement system 123 may determine a mutually available schedule based on the scheduling data at operation 1020. The mutually available schedule may be determined by comparing the received scheduling data for the transaction parties. For example, the scheduling data of a first party is compared to the scheduling data of a second party and additionally compared to the hours of operation of a location to find mutually available times. If there is no time that will satisfy all of the scheduling data, a best mutually available schedule may be determined.

At operation 1030, the transaction arrangement system 123 may present the mutually available schedule to the transaction parties. The mutually available schedule may assist in facilitating a negotiation or conversation regarding the transaction time. In further embodiments, a transaction time may be received from the transaction parties.

FIG. 11 is a flow diagram depicting a further embodiment of the method 620 for performing the transaction arrangement that may retrieve and present party verification data. At operation 1110, the transaction arrangement system 123 may retrieve party verification data associated with the transaction parties. The party verification data may be retrieved from application servers 118, third party servers 130, client devices 110 and 112, databases 126, and other sources, in example embodiments. The party verification data may include party images (e.g., provided by the party or retrieved from a social networking applications 260), credit reports, criminal history, prior ratings and reviews of the party, social networking information, biometric data, other identifying data, and other data.

At operation 1120, the transaction arrangement system 123 may present the party verification data to the transaction parties. For example, the seller transaction party may receive verification data such as credit report information that may assist in determining whether to conduct the transaction. In another example, criminal history information may be received by the transaction parties to assist in accessing the safety of conducting an in-person transaction.

In some embodiments, various party verification data may be required to arrange the transaction. For example, party images may be required before other transaction information or party information is communicated to the transaction parties. In some embodiments, image recognition hardware or software may be used to verify the party image is an image of a person. This verification may useful in preventing non-person images from being provided by the transaction parties. The party images may assist in facilitating the in-person transaction by allowing the parties to easily identify each other. Further, the party images may be used for identification of the transaction parties after the transaction should the transaction be unsuccessful. This may provide a level of safety since a transaction party being later identified may prevent nefarious activity.

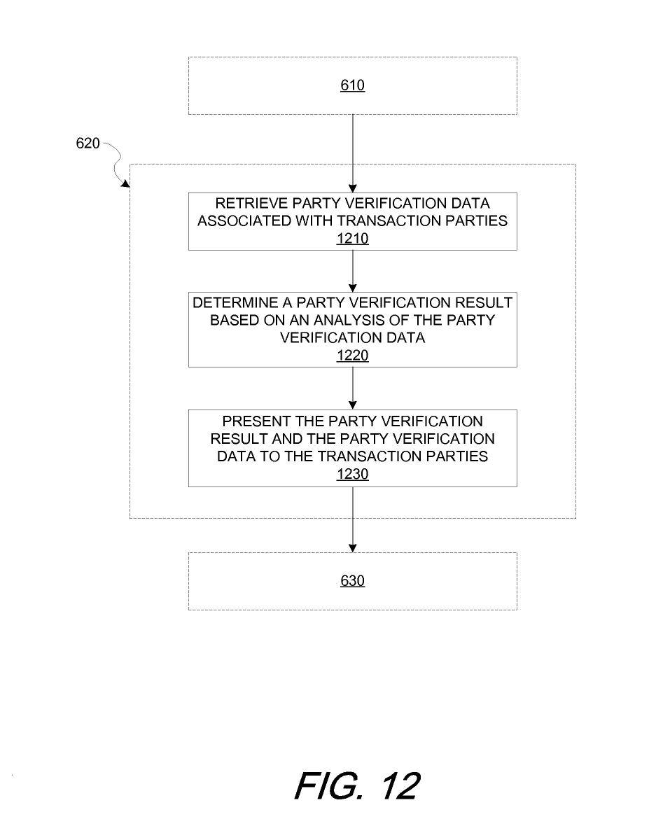

FIG. 12 is a flow diagram depicting a further embodiment of the method 620 for performing the transaction arrangement that may determine a party verification result. Similar to FIG. 11, the transaction arrangement system 123 may retrieve party verification data associated with the transaction parties at operation 1210.

At operation 1220, the transaction arrangement system 123 may determine the party verification result based on an analysis of the party verification data. For example, the party verification result may be a score that indicates safety, likelihood of a successful transaction, or another metric. In an example embodiment, the verification result may be the positive identification of the transaction parties. For example, the party verification data may include biometric data provided by the transaction parties and operation 1220 may compare the biometric data against stored biometric data to verify the party identifies. In an embodiment, the party images may be used to verify the party identities. In this embodiment, the party images may be included in the party verification data and the identities of the parties verified using image recognition hardware or software.

At operation 1230, the transaction arrangement system 123 may present the party verification result and the party verification data to the transaction parties. In embodiments, party preferences set by the transaction parties may determine what party verification data to retrieve and to present.

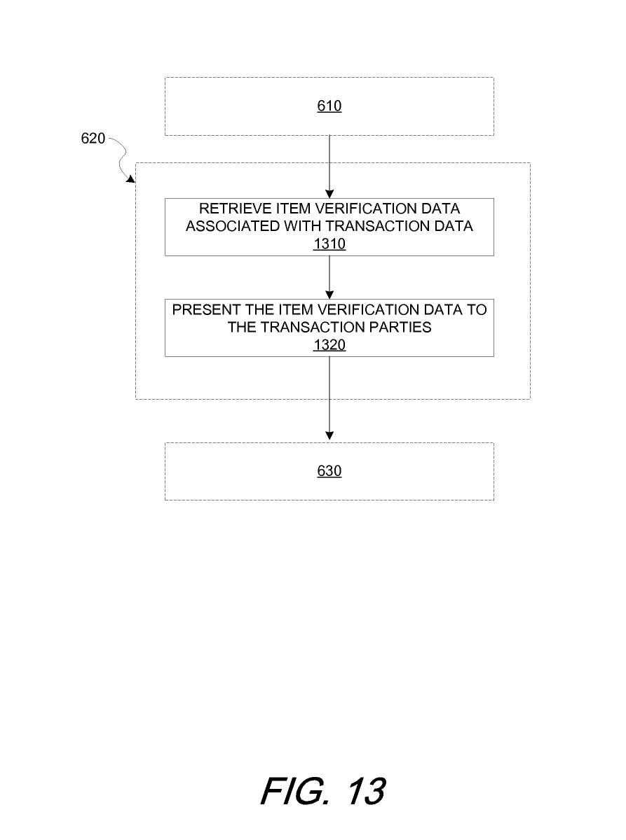

FIG. 13 is a flow diagram depicting a further embodiment of the method 620 for performing the transaction arrangement that may retrieve and present item verification data. At operation 1310, the transaction arrangement system 123 may retrieve item verification data associated with the transaction data. The item verification data may be retrieved from application servers 118, third party servers 130, client devices 110 and 112, databases 126, and other sources, in example embodiments. The item verification data may include item images, an original purchase receipt, or other data.

At operation 1320, the transaction arrangement system 123 may present the item verification data to the transaction parties. For example, the buyer transaction party may receive the original purchase receipt for the item to assist in verifying the authenticity of the item.

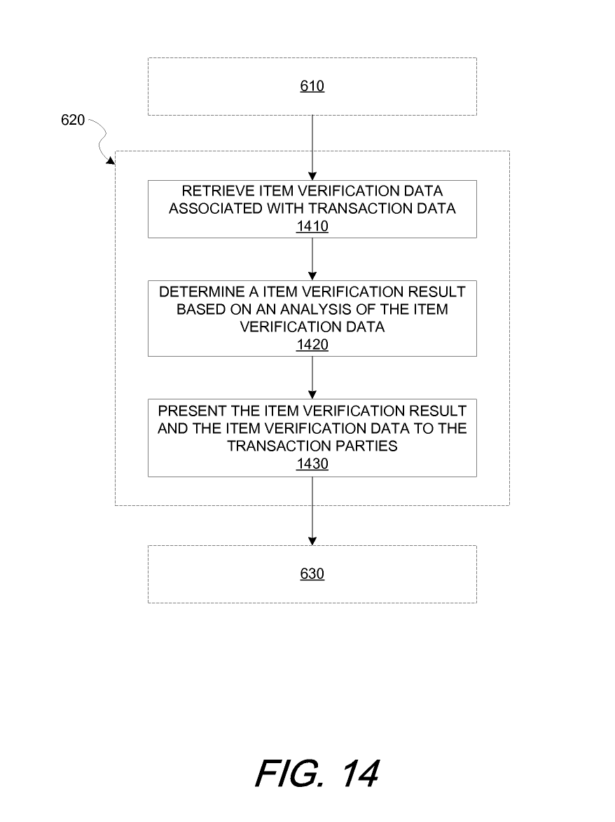

FIG. 14 is a flow diagram depicting a further embodiment of the method 620 for performing the transaction arrangement that may determine an item verification result. Similar to FIG. 13, operation 1410 may retrieve item verification data associated with the transaction data.

At operation 1420, the transaction arrangement system 123 may determine the item verification result based on an analysis of the item verification data. For example, if the item verification data includes an original purchased receipt, operation 1420 may verify the purchase by communicating a receipt identifier to a server and receive a verification result.

At operation 1430, the transaction arrangement system 123 may present the item verification result and the item verification data to the transaction parties. Similar to operation 1320, various item verification data may be present to the transaction parties along with the item verification result, such as, the verification of the original purchase receipt for example.

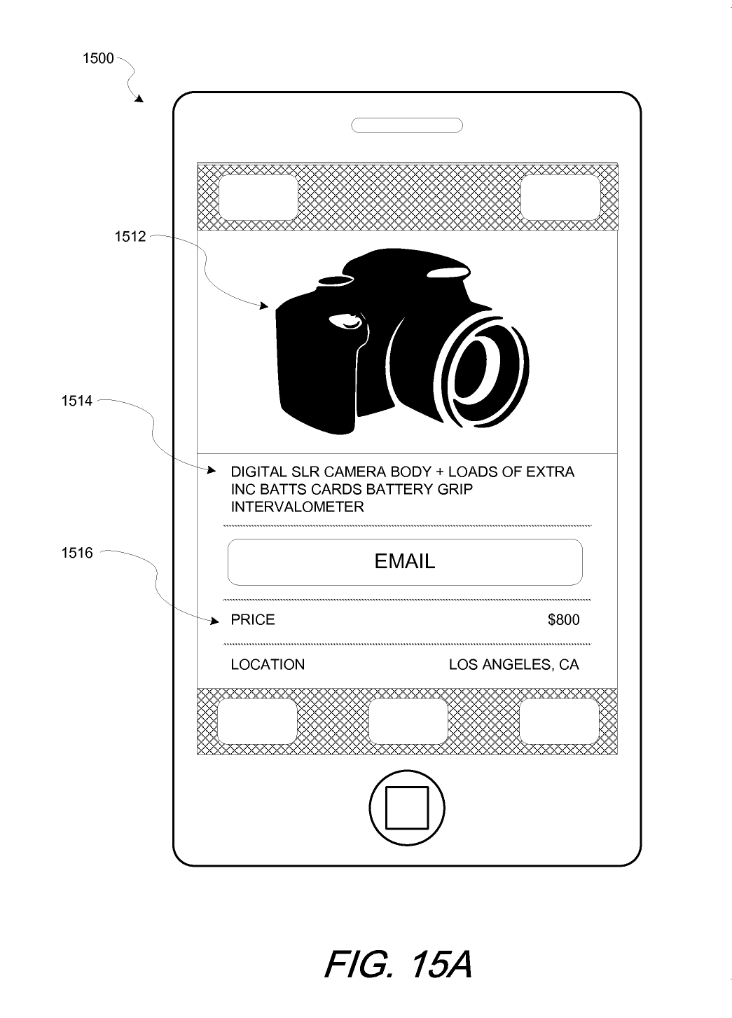

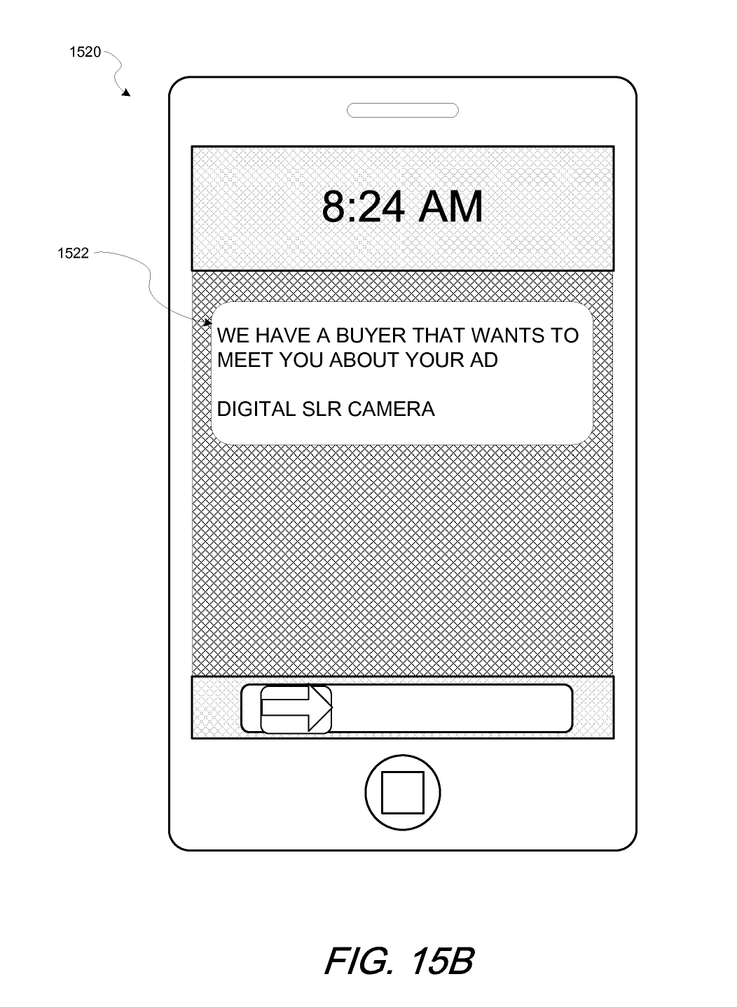

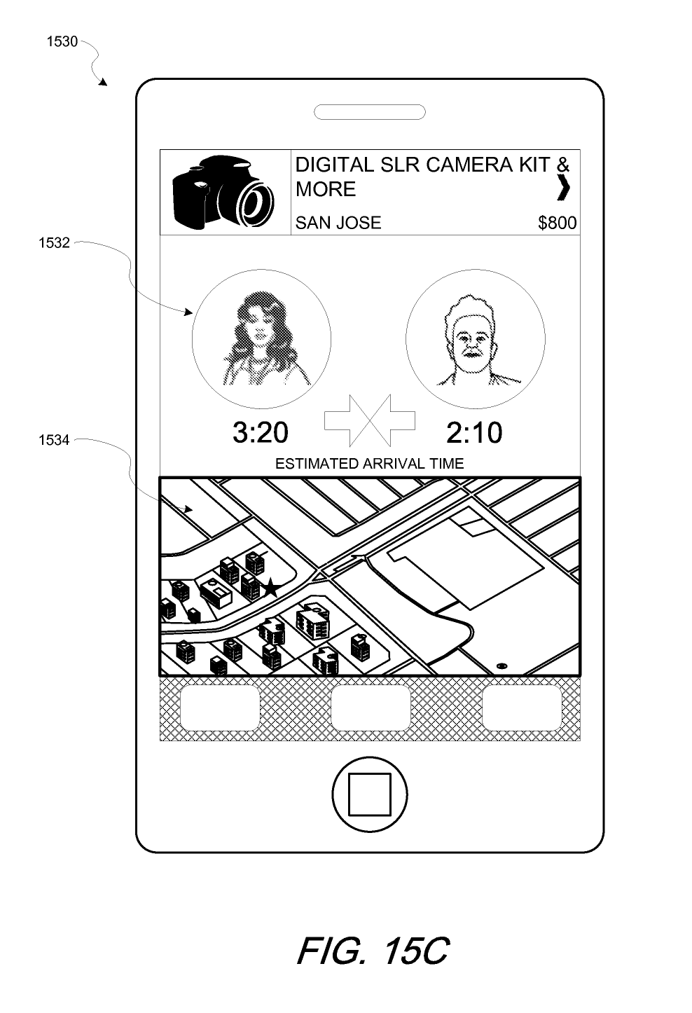

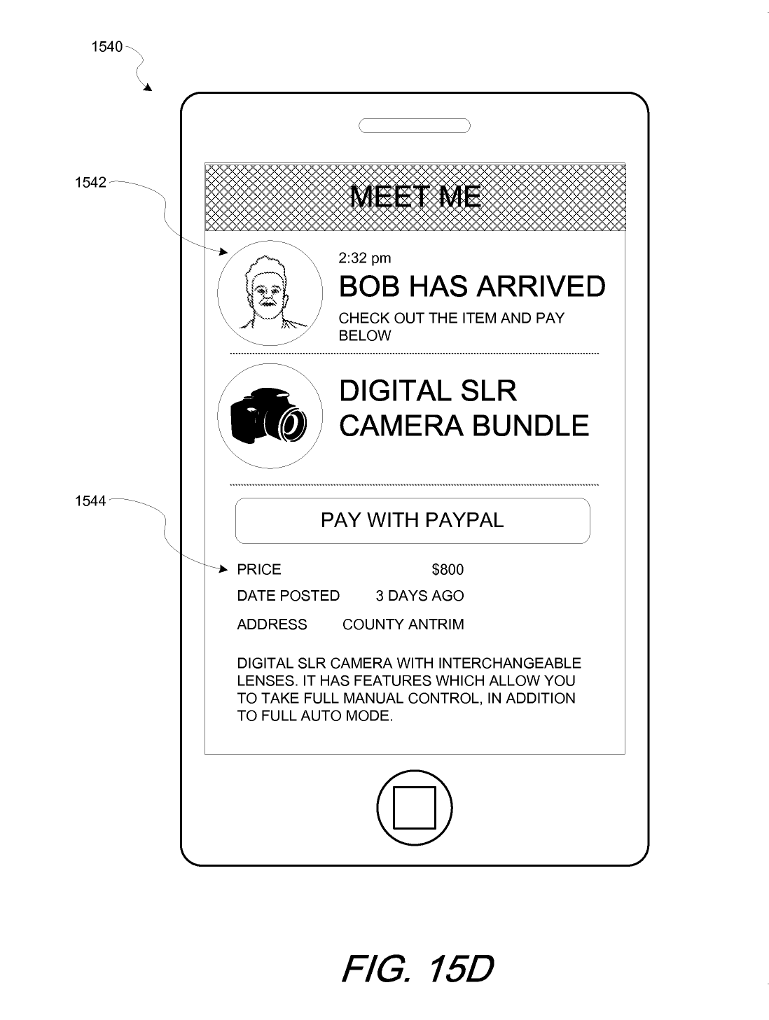

FIGS. 15A-15D depicts example embodiments of the user interfaces for transaction arrangement on a mobile device. User interface 1500 is an example user interface for an item listing. Area 1512 displays an image of the item, area 1514 displays a description of the item, area 1516 displays other information about the item that may include item price, item condition, quantity, item dimensions, item weight, location, currency, payment method, or other data. A request for a transaction may be initiated from the example user interface 1500.

User interface 1520 is an example user interface showing a notification. For example, when a transaction is initiated in user interface 1500, a notification may be received and presented at user interface 1520. Area 1522 is an example of a notification that may be received. Notifications may include transaction request notifications, scheduling notifications, location and proximity notifications, and other notifications.

User interface 1530 is an example embodiment of a user interface to perform transaction arrangement. After a transaction notification is received in user interface 1520, user interface 1530 may be used to arrange the transaction. User interface 1530 may present scheduling data, location data, party images, and other transaction arrangement information. Area 1532 shows example party images of the transaction parties. Area 1534 displays a map with the location of transaction called out. In embodiments, the map may display suggested transaction locations, be used to display current party location (as determined by a GPS unit of the mobile device), or other location information.

User interface 1540 is an example of a user interface that may be displayed when performing the transaction. After the transaction has been arranged in example user interface 1530, user interface 1540 may be used to facilitate the transaction by providing transaction information. The transaction information may include transaction scheduling, transaction location, party images, and other transaction data. Area 1542 may display estimated time of arrival (ETA) information or party proximity information. In an embodiment, area 1544 may be used to make payment for the transaction.

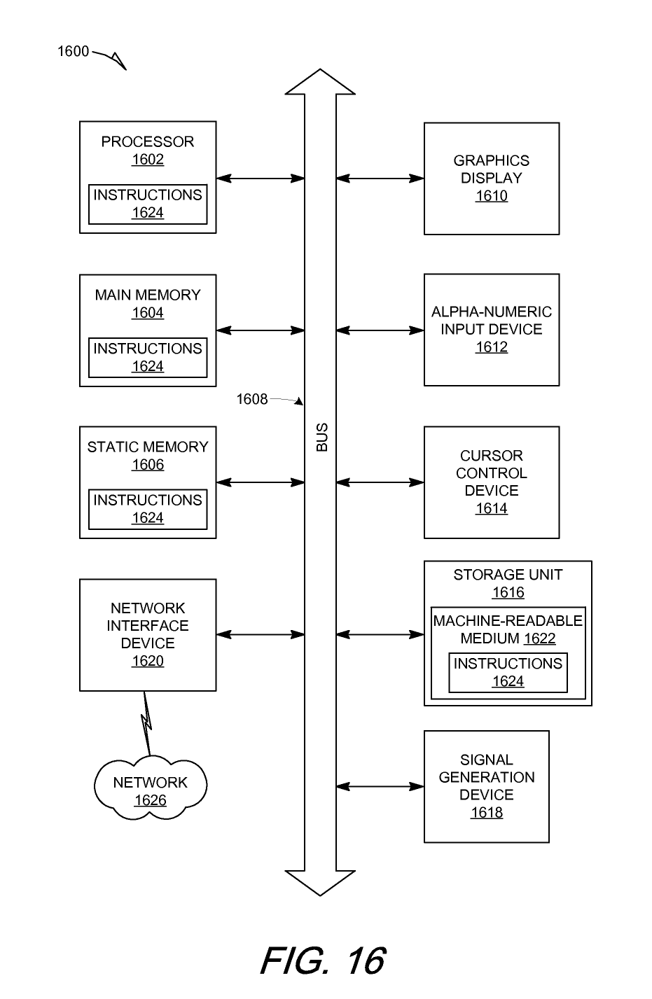

FIG. 16 is a block diagram illustrating components of a machine 1600, according to some example embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system and within which instructions 1624 (e.g., software, a program, an application, an applet, an app, or other executable code) for causing the machine 1600 to perform any one or more of the methodologies discussed herein may be executed. In alternative embodiments, the machine 1600 operates as a standalone device or may be connected (e.g., networked) to other machines. In a networked deployment, the machine 1600 may operate in the capacity of a server machine or a client machine in a server-client network environment, or as a peer machine in a peer-to-peer (or distributed) network environment. The machine 1600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1624, sequentially or otherwise, that specify actions to be taken by that machine. Further, while only a single machine is illustrated, the term “machine” shall also be taken to include a collection of machines that individually or jointly execute the instructions 1624 to perform any one or more of the methodologies discussed herein.

The machine 1600 includes a processor 1602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1604, and a static memory 1606, which are configured to communicate with each other via a bus 1608. The machine 1600 may further include a graphics display 1610 (e.g., a plasma display panel (PDP), a light emitting diode (LED) display, a liquid crystal display (LCD), a projector, or a cathode ray tube (CRT)). The machine 1600 may also include an alphanumeric input device 1612 (e.g., a keyboard), a cursor control device 1614 (e.g., a mouse, a touchpad, a trackball, a joystick, a motion sensor, or other pointing instrument), a storage unit 1616, a signal generation device 1618 (e.g., a speaker), and a network interface device 1620.

The storage unit 1616 includes a machine-readable medium 1622 on which is stored the instructions 1624 embodying any one or more of the methodologies or functions described herein. The instructions 1624 may also reside, completely or at least partially, within the main memory 1604, within the processor 1602 (e.g., within the processor's cache memory), or both, during execution thereof by the machine 1600. Accordingly, the main memory 1604 and the processor 1602 may be considered as machine-readable media. The instructions 1624 may be transmitted or received over a network 1626 via the network interface device 1620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1600), such that the instructions, when executed by one or more processors of the machine (e.g., processor 1602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. Furthermore, the machine-readable medium is non-transitory in that it does not embody a propagating signal. However, labeling the machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1624 may further be transmitted or received over a communications network 1626 using a transmission medium via the network interface device 1620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A system, comprising:
a processor;
a transaction arrangement module executable by the processor and configured to:
receive a transaction request from a first transaction party, the transaction request includes transaction data that is associated with transaction parties that include the first transaction party;
retrieve geographic region data associated with the transaction parties that use the transaction data;
determine a mutual geographic region based on the geographic region data;
determine suggested transaction locations based on the mutual geographic region; and
recommend the suggested transaction locations to the transaction parties.

2. The system of claim 1, further comprising:
the transaction arrangement module further configured to store a transaction location selection in a database, to be used in additional analysis by the transaction arrangement module in the future.

3. The system of claim 1, further comprising:
the transaction arrangement module further configured to:
retrieve suggested transaction location data based on the mutual geographic region from at least one application server; and
determine suggested transaction locations based on the mutual geographic region based on an analysis of the suggested transaction location data.

4. The system of claim 3, wherein the suggested transaction location data includes prior transaction location selections associated with the transaction parties.

5. The system of claim 3, wherein the suggested transaction location data includes prior transaction location selections associated with a plurality of other transaction parties.

6. The system of claim 1, further comprising:
the transaction arrangement module further configured to:
retrieve party verification data associated with the transaction parties using the transaction data; and
the transaction arrangement module further configured to present the party verification data to the transaction parties.

7. The system of claim 6, wherein the party verification data includes party images; and
the transaction arrangement module further configured to perform verification of the party images.

8. The system of claim 6, wherein the party verification data is required to perform transaction arrangement.

9. The system of claim 1, further comprising:
the transaction arrangement module further configured to:
retrieve item verification data associated with the transaction data; and
present the item verification data to the transaction parties.

10. The system of claim 1, further comprising:
the transaction arrangement module further configured to:
retrieve scheduling data associated with the transaction parties using the transaction data;
determine a mutually available schedule based on the scheduling data; and
recommend the mutually available schedule to the transaction parties.

11. A method, comprising:
receiving a transaction request from a first transaction party, the transaction request including transaction data that is associated with transaction parties that include the first transaction party;
retrieving geographic region data associated with the transaction parties using the transaction data;
determining a mutual geographic region based on the geographic region data;
determining suggested transaction locations based on the mutual geographic region; and
recommending the suggested transaction locations to the transaction parties.

12. The method of claim 11, further comprising:
storing a transaction location selection in a database, to be used in additional analysis in the future.

13. The method of claim 1, further comprising:
retrieving suggested transaction location data based on the mutual geographic region from at least one application server; and
determining suggested transaction locations based on the mutual geographic region based on an analysis of the suggested transaction location data.

14. The method of claim 13, wherein the suggested transaction location data includes prior transaction location selections associated with the transaction parties.

15. The method of claim 13, wherein the suggested transaction location data includes prior transaction location selections associated with a plurality of other transaction parties.

16. The method of claim 11, further comprising:
retrieving party verification data associated with the transaction parties using the transaction data; and
presenting the party verification data to the transaction parties.

17. The method of claim 16, wherein the party verification data includes party images; and
performing verification of the party images.

18. The method of claim 11, further comprising:
retrieving item verification data associated with the transaction data; and
presenting the item verification data to the transaction parties.

19. The method of claim 11, further comprising:
retrieving scheduling data associated with the transaction parties using the transaction data;
determining a mutually available schedule based on the scheduling data; and
recommending the mutually available schedule to the transaction parties.

20. A non-transitory machine readable medium that stores instructions that, when executed by a machine, cause the machine to:
receive a transaction request from a first transaction party, the transaction request including transaction data that is associated with transaction parties that include the first transaction party;
retrieve geographic region data associated with the transaction parties that use the transaction data;
determine a mutual geographic region based on the geographic region data;
determine suggested transaction locations based on the mutual geographic region; and
recommend the suggested transaction locations to the transaction parties.
